(19) United States
(12) Patent Application Publication
(10) Pub. No.: US 2020/0339174 A1
(43) Pub. Date: Oct. 29, 2020

(54) VEHICLE STEERING SWITCH SYSTEM AND STORAGE MEDIUM STORING SWITCH FUNCTION SWITCHING PROGRAM

(71) Applicant: DENSO CORPORATION, Kariya-city (JP)

(72) Inventor: Tomohiko SAKAMAKI, Kariya-city (JP)

(21) Appl. No.: 16/927,262

(22) Filed: Jul. 13, 2020

Related U.S. Application Data
(63) Continuation of application No. PCT/JP2018/040334, filed on Oct. 30, 2018.

(30) Foreign Application Priority Data
Jan. 15, 2018 (JP) 2018-004259

(51) Int. Cl. B62D 1/04; B60K 35/00

(52) U.S. Cl. CPC B62D 1/046; B60K 2370/12; B60K 35/00

(57) ABSTRACT

In a vehicle steering switch system, an operation switch is disposed in a vehicle steering wheel. A displays a display image. An operation detector detects operation of a user on the operation switch. A process corresponding to a function assigned to the operation switch at a detected time is executed. The display image displayed on the display is associated to the function assigned to the operation switch and switching of the display image or the function is performed.

### CROSS REFERENCE TO RELATED APPLICATIONS

The present application is a continuation application of International Patent Application No. PCT/JP2018/040334 filed on Oct. 30, 2018, which designated the U.S. and claims the benefit of priority from Japanese Patent Application No. 2018-004259 filed on Jan. 15, 2018. The entire disclosures of all of the above applications are incorporated herein by reference.

### TECHNICAL FIELD

The present disclosure relates to a steering switch system for a vehicle, a switch function switching program, and a storage medium.

### BACKGROUND

A vehicle steering switch system is provided in which an operation switch that can be operated by a user who is a driver is disposed in a steering wheel of a vehicle. In the vehicle steering switch system, the user can perform, for example, volume adjustment of an audio function or temperature adjustment of an air conditioning function by operating the operation switch without moving the sight line from a front of the vehicle even while the vehicle is traveling.

### SUMMARY

In a vehicle steering switch system, an operation switch is disposed in a vehicle steering wheel. A displays a display image. An operation detector detects operation of a user on the operation switch. A process corresponding to a function assigned to the operation switch at a detected time is executed. The display image displayed on the display is associated to the function assigned to the operation switch and switching of the display image or the function is performed.

### BRIEF DESCRIPTION OF DRAWINGS

The above and other features and advantages of the present disclosure will become more apparent from the following detailed description made with reference to the accompanying drawings. In the drawings,

FIG. 1 is a diagram showing a peripheral configuration of a steering wheel in a vehicle compartment according to a first embodiment.

FIG. 2 is a functional block diagram.

FIG. 3 is a diagram showing a peripheral configuration of a seesaw-type operation switch.

FIG. 4 is a diagram showing association between operation switches and various functions.

FIG. 5 is a flowchart.

FIG. 6 is a diagram (part 1) showing a mode in which the function of a display image or an operation switch is switched to another.

FIG. 7 is a diagram (part 2) showing a mode in which the function of a display image or an operation switch is switched to another.

FIG. 8 is a diagram (part 3) showing how the function of the display image or the operation switch are switched to another.

FIG. 9 is a diagram (part 4) showing how the function of the display image or the operation switch are switched to another.

FIG. 10 is a diagram (part 5) showing how the function of the display image or the operation switch are switched to another.

FIG. 11 is a diagram showing a peripheral configuration of a push type operation switch.

FIG. 12 is a diagram showing a peripheral configuration of a toggle type operation switch.

FIG. 13 is a diagram showing a peripheral configuration of a wheel type operation switch.

FIG. 14 is a diagram showing a peripheral configuration of a cross key type operation switch.

FIG. 15 is a diagram showing a peripheral configuration of a seesaw-type operation switch according to a second embodiment.

FIG. 16 is a diagram showing association between the operation switches and various functions.

FIG. 17 is a diagram showing a peripheral configuration of a seesaw-type operation switch according to a third embodiment.

FIG. 18 is a functional block diagram.

FIG. 19 is a diagram showing a mode in which none of marks are displayed.

FIG. 20 is a diagram showing a mode in which a mark of an air conditioning function is displayed.

FIG. 21 is a diagram showing a mode in which a mark of a navigation function is displayed.

### DETAILED DESCRIPTION

In a first comparative example of a vehicle steering switch system, a placement mode of an operation switch disposed in a steering wheel and a placement mode of a button displayed on a head-up display are aligned to improve operability. In a second comparative example, another function is assigned to an autocruise switch disposed in the steering wheel of the vehicle. In a third comparative example, a function corresponding to a user's preference is freely assigned to the operation switch disposed in the steering wheel of the vehicle.

In the first comparative example, when the number of operation switches is increased, there is a difficulty that all of the operation switches cannot be disposed in the steering wheel, and there is a difficulty that the user is confused at the time of operation. In addition, since the user operates while watching the placement mode of the buttons displayed on a head-up display, there is also a difficulty that blind operation is difficult. In the second comparative example, when a vehicle speed reaches a predetermined speed, the autocruise switch is switched to the switch of an original autocruise function, so that the autocruise switch cannot be used as the operation switch of another function while the vehicle is traveling. For that reason, there is a need to separately provide operation switches such as an audio function and an air conditioning function which are frequently used while the vehicle is traveling. In the third comparative example, there is a difficulty that a method of assigning the function to the operation switch becomes complicated. In addition, although the mode in which the function is assigned to the operation switch can be displayed on the head-up display, there is also a difficulty that the operation switch to be operated first cannot be grasped because the mode is not displayed unless one of the operation switches is first operated.

One example of the present disclosure provides a vehicle steering switch system, a switch function switching program, and a storage medium in which a user can appropriately adjust and set multiple functions without increasing the number of operation switches and without confusing the user.

According to one example embodiment, an operation detector detects operation of a user on an operation switch disposed in a vehicle steering. A process execution unit executes, when the operation of the user on the operation switch is detected, a process corresponding to a function assigned to the operation switch at a detected time. A switching controller associates a display image displayed on a display to the function assigned to the operation switch and performs switching of the display image or the function.

The display image displayed on the display and the function assigned to the operation switch are associated with each other. Even when the user does not gaze on the display image, the user can recognize the function assigned to the operation switch at that point in time only by observing the display image for a moment. This makes it possible for the user to appropriately adjust and set the multiple functions without increasing the number of operation switches arranged in a limited space such as a steering wheel and without confusing the user.

### First Embodiment

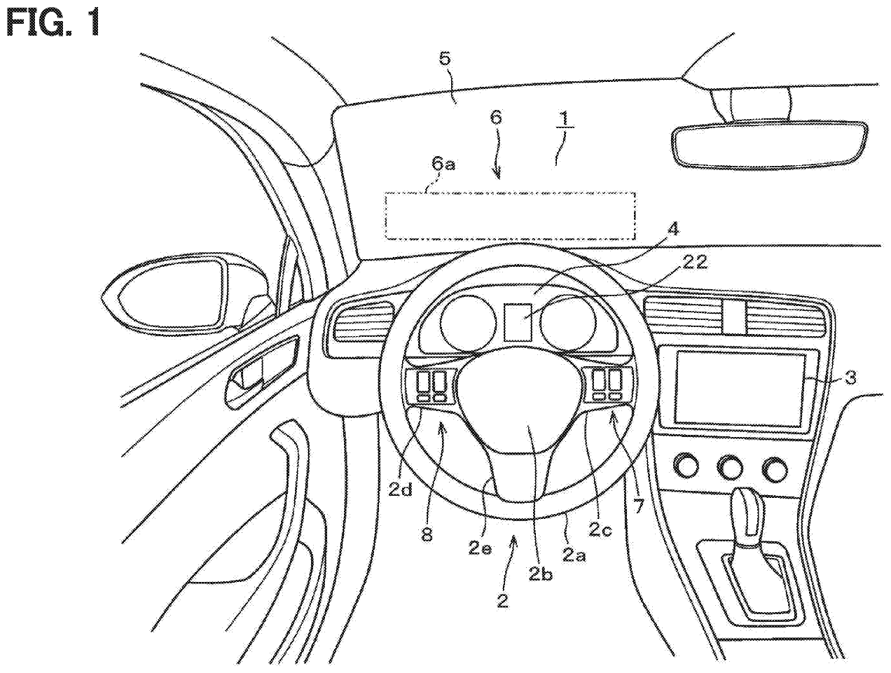

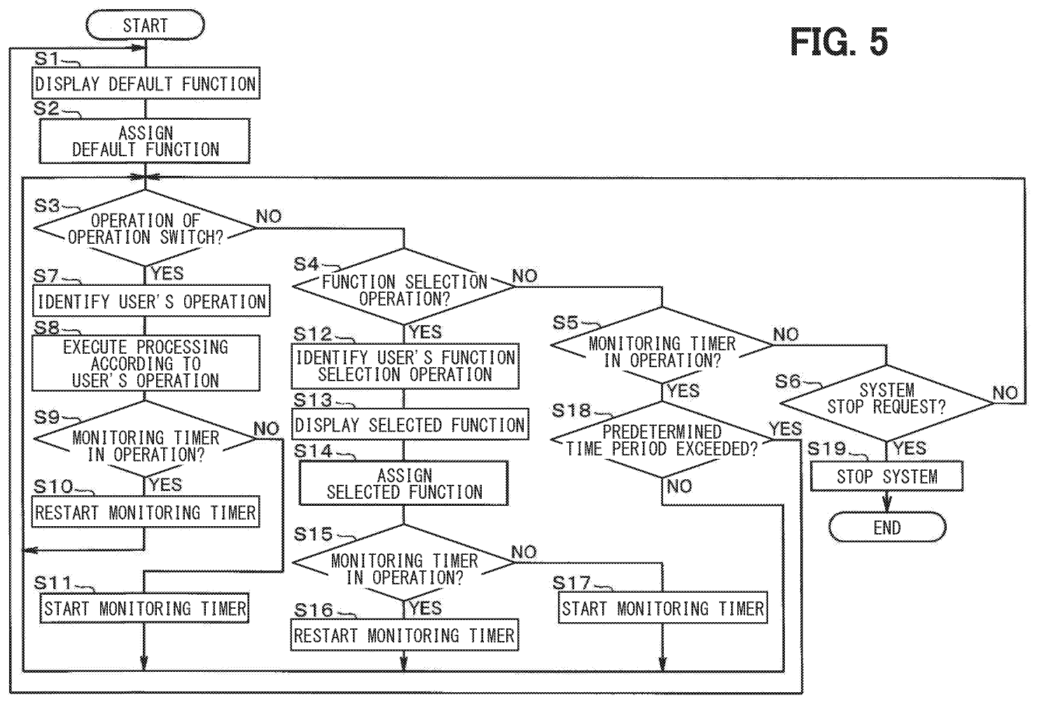

A first embodiment will be described below with reference to FIGS. 1 to 13. In the present embodiment, a configuration in which a steering switch system 1 is mounted on a vehicle in which a driver's seat is disposed on a left side when viewed in a vehicle forward direction will be exemplified.

As shown in FIG. 1, in a vehicle compartment, a center display 3 and a meter 4 are disposed around a steering wheel 2, and a portion of a front windshield 5 in front of a driver's seat is a display area 6a of a head-up display 6. An in-meter display 22, which will be described later, is disposed in the meter 4. The steering wheel 2 includes an annular ring portion 2a, a pad portion 2b in which an air-bag is incorporated, a right spoke portion 2c, a left spoke portion 2d, and a lower spoke portion 2e. Switch groups 7 and 8 each including various switches that can be operated by the user who is the driver are placed on the spoke portions 2c and 2d, and any of the switches can be operated by the user without moving a sight line from the front of the vehicle even while the vehicle is traveling.

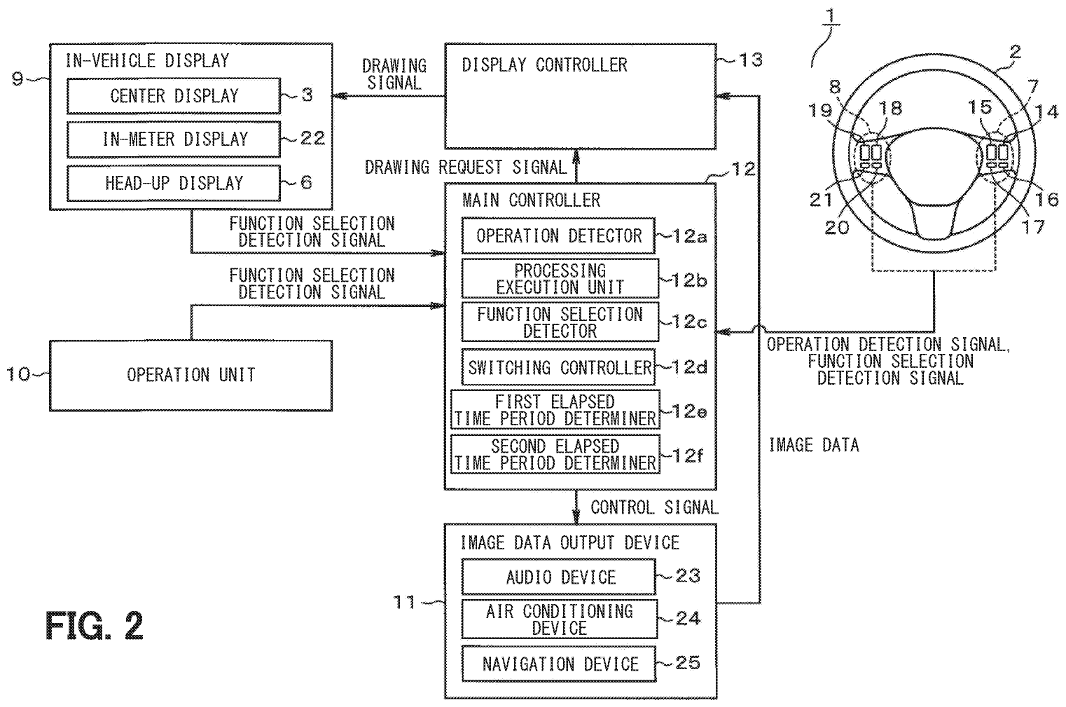

As shown in FIG. 2, the vehicle steering switch system 1 includes switch groups 7 and 8, an in-vehicle display 9, an operation unit 10, an image data output device 11, a main control unit 12, and a display control unit 13. All of those components may be individually configured or partially integrated. The switch groups 7 and 8 and the main control unit 12 are connected to each other by a vehicle harness. A connection by the vehicle harnesses may be performed by an in-vehicle LAN such as CAN (Controller Area Network, registered trademark), FlexRay (registered trademark), MOST (Media Oriented Systems Transport, registered trademark), or AVC-LAN (Audio visual Communication-Local Area Network).

The right switch group 7 disposed on the right spoke portion 2c is a switch group to which a multimedia system functions are assigned, and includes four switches 14 to 17 of, a first operation switch 14, a second operation switch 15, a first function selection switch 16, and a second function selection switch 17. The multimedia system functions include an audio function, an air conditioning function, a navigation function, or the like. The left switch group 8 disposed on the left spoke portion 2d is a switch group to which a traveling system function is assigned, and includes four switches 18 to 21 of a third operation switch 18, a fourth operation switch 19, a third function selection switch 20, and a fourth function selection switch 21. The traveling system functions includes a function of setting a speed of an autocruise, a function of driving support operated while watching a meter display, or the like.

Those switch groups 7 and 8 can be advantageously operated by the user without movement of the sight line from the front of the vehicle even when the vehicle is traveling as described above. However, the space is limited, and the number of switch groups is limited from the viewpoint of operability and design. Since the four operation switches 14, 15, 18, and 19 have basically the same configuration and the four function selection switches 16, 17, 20, and 21 have basically the same configuration, the operation switches 14 and 15 and the function selection switches 16 and 17 will be described hereinafter, and a description of the operation switches 18 and 19 and the function selection switches 20 and 21 will be omitted.

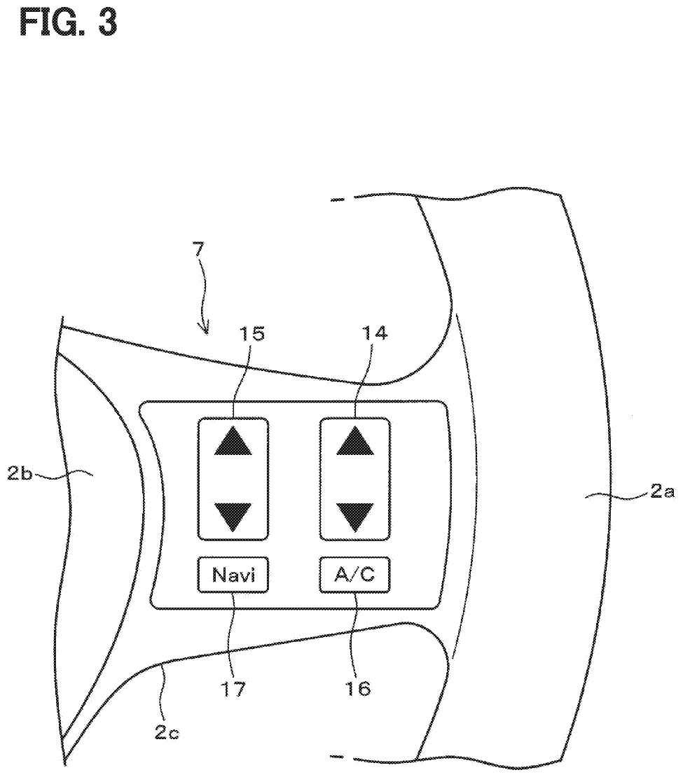

As shown in FIG. 3, the operation switches 14 and 15 are disposed side by side in a lateral direction. Each of the operation switches 14 and 15 is a seesaw-type switch that can be tilted in the vertical direction, and when operated by the user, outputs an operation detection signal indicating the operation to the main control unit 12. The function selection switches 16 and 17 are disposed below the operation switches 14 and 15 side by side in the lateral direction. Each of the function selection switches 16 and 17 is a push-type switch, and when operated by the user, outputs a function selection detection signal indicating the operation to the main control unit 12. In other words, in a case where the first function selection switch 16 is assigned as the function selection switch of the air conditioning function, when the user operates the first function selection switch 16, the first function selection switch 16 outputs a function selection detection signal indicating that the user has selected the air conditioning function to the main control unit 12. In a case where the second function selection switch 17 is assigned as a function selection switch of the navigation function, when the user operates the second function selection switch 17, the second function selection switch 17 outputs a function selection detection signal indicating that the user has selected the navigation function to the main control unit 12. The operation switches 14 and 15 and the function selection switches 16 and 17 are made different in surface irregularities or shape from each other so that the user can grasp which of the operation switches the user operates even with blind, and the user can perform blind operation. The operation switches may be distinguishable from each other by the user by attaching characters or symbols to the surfaces of the operation switches.

The in-vehicle display 9 includes the center display 3 described above, the in-meter display 22 disposed on the meter 4, and the head-up display 6 described above. When a drawing signal is input from the display control unit 13, the in-vehicle display 9 draws and displays a display image corresponding to the input drawing signal. The center display 3 of the in-vehicle display 9, for example, has a touch function of displaying a touch button that can be operated by the user on the touch panel, and when the user operates the touch button, the center display 3 outputs a signal indicating the operation to the main control unit 12. In other words, when the user operates a touch button of the audio function in a state where an icon of the audio function is displayed as the touch button, the center display 3 outputs a function selection detection signal indicating that the user has selected the audio function to the main control unit 12. The same applies to a case in which icons of the air conditioning function and the navigation function are displayed as touch buttons.

The operation unit 10 is, for example, a mechanical switch disposed around the center display 3, and when the user operates the mechanical switch, the operation unit 10 outputs a signal indicating the operation to the main control unit 12. In other words, a switch for the audio function is disposed around the center display 3, and when the user operates the switch for the audio function, the operation unit 10 outputs a function selection detection signal indicating that the user has selected the audio function to the main control unit 12. The same applies to a case in which switches for the air conditioning function and the navigation function are disposed around the center display 3.

The image data output device 11 includes an audio device 23, an air conditioning device 24, and a navigation device 25, and outputs image data to the display control unit 13, and when receiving a control signal from the main control unit 12, the image data output device 11 executes processing according to the input control signal. In other words, the audio device 23 outputs the image data of the audio display image to the display control unit 13, and when receiving the control signal from the main control unit 12, the audio device 23 performs the volume adjustment and channel selection/music selection setting or the like according to the input control signal. The air conditioning device 24 outputs the image data of the air conditioner display image to the display control unit 13, and when receiving the control signal from the main control unit 12, the air conditioning device 24 executes a temperature adjustment, an air volume adjustment or the like in accordance with the received control signal. The navigation device 25 outputs the image data of the navigation display image to the display control unit 13, and when receiving the control signal from the main control unit 12, the navigation device 25 executes a map scaling setting, a destination setting, or the like in accordance with the received control signal.

The main control unit 12 includes a microcomputer including a CPU (Central Processing Unit), a ROM (Read Only Memory), a RAM (Random Access Memory), and an I/O (Input/Output). The microcomputer executes a computer program stored in a non-transitory tangible storage medium, and executes a process corresponding to the computer program. The computer program executed by the microcomputer includes a switch function switching program. The main control unit 12 includes an operation detector 12a, a processing execution unit 12b, a function selection detector 12c, a switching controller 12d, a first elapsed time period determiner 12e, and a second elapsed time period determiner 12f.

When receiving the operation detection signal from the first operation switch 14, the operation detector 12a detects the user's operation on the first operation switch 14, and when receiving the operation detection signal from the second operation switch 15, the operation detector 12a detects the user's operation on the second operation switch 15.

When detecting the user's operation on the operation switches 14 and 15, the processing execution unit 12b executes a process corresponding to the function assigned to the operation switches 14 and 15 at that time. In other words, in a case where the volume adjustment of the audio function is assigned to the first operation switch 14, the processing execution unit 12b outputs a control signal instructing the volume adjustment corresponding to the user's operation to the audio device 23 when the user's operation on the first operation switch 14 is detected. In a case where the channel selection/music selection setting of the audio function is assigned to the second operation switch 15, the processing execution unit 12b outputs a control signal instructing the channel selection/music selection setting corresponding to the user's operation to the audio device 23 when the user's operation on the second operation switch 15 is detected.

In a case where the temperature adjustment of the air conditioning function is assigned to the first operation switch 14, the processing execution unit 12b outputs a control signal instructing the temperature adjustment corresponding to the user's operation to the air conditioning device 24 when the user's operation on the first operation switch 14 is detected. In a case where the air volume adjustment of the air conditioning function is assigned to the second operation switch 15, the processing execution unit 12b outputs a control signal instructing the air volume adjustment corresponding to the user's operation to the air conditioning device 24 when the user's operation on the second operation switch 15 is detected.

In a case where the map scaling setting of the navigation function is assigned to the first operation switch 14, the processing execution unit 12b outputs a control signal instructing the map scaling setting corresponding to the user's operation to the navigation device 25 when the user's operation on the first operation switch 14 is detected. In a case where the destination setting of the navigation function is assigned to the second operation switch 15, the processing execution unit 12b outputs a control signal instructing the destination setting corresponding to the user's operation to the navigation device 25 when the user's operation on the second operation switch 15 is detected.

When receiving the function selection detection signal from the first function selection switch 16, the function selection detector 12c detects the function selection operation by the user on the first function selection switch 16, and identifies the function selected by the user's operation on the first function selection switch 16. When receiving the function selection detection signal from the second function selection switch 17, the function selection detector 12c detects the function selection operation by the user on the second function selection switch 17, and identifies the function selected by the user's operation on the second function selection switch 17. When receiving the function selection detection signal from the center display 3, the function selection detector 12c detects the function selection operation by the user on the center display 3, and identifies the function selected by the user's operation on a touch panel of the center display 3. The function selection detector 12c detects the function selection operation by the user on the operation unit 10 upon receiving the function selection detection signal from the operation unit 10, and identifies the function selected by the user's operation on the operation unit 10.

The switching controller 12d switches the display image displayed on the in-vehicle display 9 and the function assigned to the operation switches 14 and 15 in association with each other. When the function selected by the user is identified by the function selection detector 12c as described above, the switching controller 12d outputs a drawing request signal corresponding to the identified function to the display control unit 13, and processes the signals input from the operation switches 14 and 15 thereafter in accordance with the identified function.

The first elapsed time period determiner 12e determines whether an elapsed time period (corresponding to a first elapsed time period) has exceeded a predetermined time period (corresponding to a first predetermined time period), the elapsed time period starting from a time at which the function selection operation by the user is detected and, the user's operation on the operation switches 14 and 15 being not detected during the elapsed time period. When the elapsed time period determiner 12e determines that the elapsed time period has exceeded a predetermined time period, similarly, the elapsed time period determiner 12e outputs the drawing request signal to the display control unit 13.

The second elapsed time period determiner 12f determines whether the elapsed time period (corresponding to a second elapsed time period) has reached a predetermined time period (corresponding to a second predetermined time period), the elapsed time period starting from a time at which the user's operation on the operation switches 14 and 15 is detected and, the next operation by the user on the operation switches 14 and 15 being not detected during the elapsed time period. When the elapsed time period determiner 12f determines that the elapsed time period has exceeded a predetermined time period, similarly, the elapsed time period determiner 12e outputs the drawing request signal to the display control unit 13. The predetermined time period in the first elapsed time period determiner 12e and the predetermined time period in the second elapsed time period determiner 12f may be the same or different.

The display control unit 13 includes a microcomputer including a CPU, a ROM, a RAM, and an I/O. When receiving a drawing request signal from the main control unit 12, the display control unit 13 outputs a drawing signal corresponding to the received drawing request signal to the in-vehicle display 9. In other words, when receiving the drawing request signal of the audio display image from the main control unit 12, the display control unit 13 outputs a drawing signal instructing drawing of the audio display image to the in-vehicle display 9, and displays the audio display image on the in-vehicle display 9. The display control unit 13 outputs a drawing signal instructing drawing of the air conditioner display image or the navigation display image to the in-vehicle display 9, and displays the air conditioner display image or the navigation display image on the in-vehicle display 9, similarly to the case of receiving the drawing request signal of the air conditioner display image or the navigation display image from the main control unit 12.

In the configuration described above, the main control unit 12 and the display control unit 13 are configured by separate microcomputers. However, the main control unit 12 and the display control unit 13 may be configured by a single microcomputer.

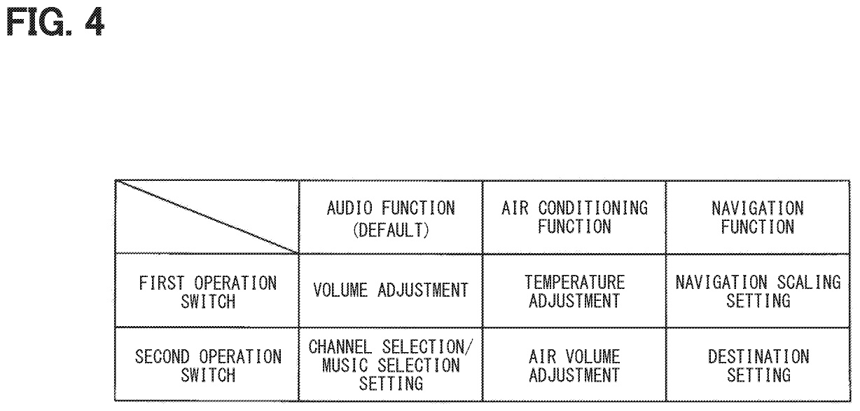

Next, the operation of the configuration described above will be described with reference to FIGS. 4 to 13. In this example, a case will be described in which the association between the operation switches 14 and 15 and various functions of the audio function, the air conditioning function, and the navigation function is set as shown in FIG. 4.

When the vehicle steering switch system 1 is activated, the main control unit 12 starts an operation monitoring process, outputs a drawing request signal to the display control unit 13, and displays a display image of a default function on the in-vehicle display 9 (S1). The main control unit 12 assigns the default function to the operation switches 14 and 15 at the same timing as when the display image of the default function is displayed on the in-vehicle display 9 (S2).

The main control unit 12 monitors whether the user has operated the operation switches 14 and 15 (S3), monitors whether the function selection operation has been performed by the user (S4), monitors whether a monitoring timer is in operation (S5), and monitors whether a stop request of the vehicle steering switch system 1 has occurred (S6).

When the main control unit 12 receives the operation detection signals from the operation switches 14 and 15 and determines that the user has operated the operation switches 14 and 15 (YES in S3), the main control unit 12 identifies the operation by the user (S7). The main control unit 12 outputs a control signal corresponding to the identified user's operation to the image data output device 11, and causes the image data output device 11 to execute a process corresponding to the operation by the user (S8). The main control unit 12 determines whether the monitoring timer is in operation (S9), and when determining that the monitoring timer is in operation (YES in S9), the main control unit 12 restarts the monitoring timer (S10), and returns to Steps S3 to S6 described above. When the main control unit 12 determines that the monitoring timer is not in operation (NO in S9), the main control unit 12 starts the monitoring timer (S11), and returns to Steps S3 to S6 described above.

When the main control unit 12 receives the function selection detection signal from the function selection switches 16 and 17, the in-vehicle display 9, or the operation unit 10 and determines that the function selection operation has been performed by the user (YES in S4, corresponding to the condition fulfillment determination procedure), the main control unit 12 identifies the function selection operation by the user (S12). The main control unit 12 outputs a drawing request signal corresponding to the identified user's function selection operation to the display control unit 13, and causes the display image of the function selected by the function selection operation to be displayed on the in-vehicle display 9 (S13, corresponding to a switching control procedure).

The main control unit 12 assigns the selected function to the operation switches 14 and 15 at the same timing as when the display image of the selected function is displayed on the in-vehicle display 9 (S14, corresponding to a switching control procedure). In other words, the main control unit 12 switches the functions assigned to the operation switches 14 and 15 at the timing of switching the display image. The main control unit 12 determines whether the monitoring timer is in operation (S15), and when determining that the monitoring timer is in operation (YES in S15), the main control unit 12 restarts the monitoring timer (S16), and returns to Steps S3 to S6 described above. When the main control unit 12 determines that the monitoring timer is not in operation (NO in S15), the main control unit 12 starts the monitoring timer (S17), and returns to Steps S3 to S6 described above.

When the main control unit 12 determines that the monitoring timer is in operation (YES in S5), the main control unit 12 determines whether a measurement time by the monitoring timer has exceeded a predetermined time period (S18). When the main control unit 12 determines that the measurement time by the monitoring timer has not reached the predetermined time period (NO in S18), the main control unit 12 returns to Steps S3 to S6 described above. When the main control unit 12 determines that the measurement time by the monitoring timer has reached the predetermined time period (YES in S18), the process returns to Step S1 described above.

When the main control unit 12 determines that no stop request for the vehicle steering switching system 1 has occurred (NO in S6), the process returns to Steps S3 to S6 described above. When the main control unit 12 determines that a stop request for the vehicle steering switch system 1 has occurred (YES in S6), the main control unit 12 stops the vehicle steering switch system 1 (S19), and completes the operation monitoring process.

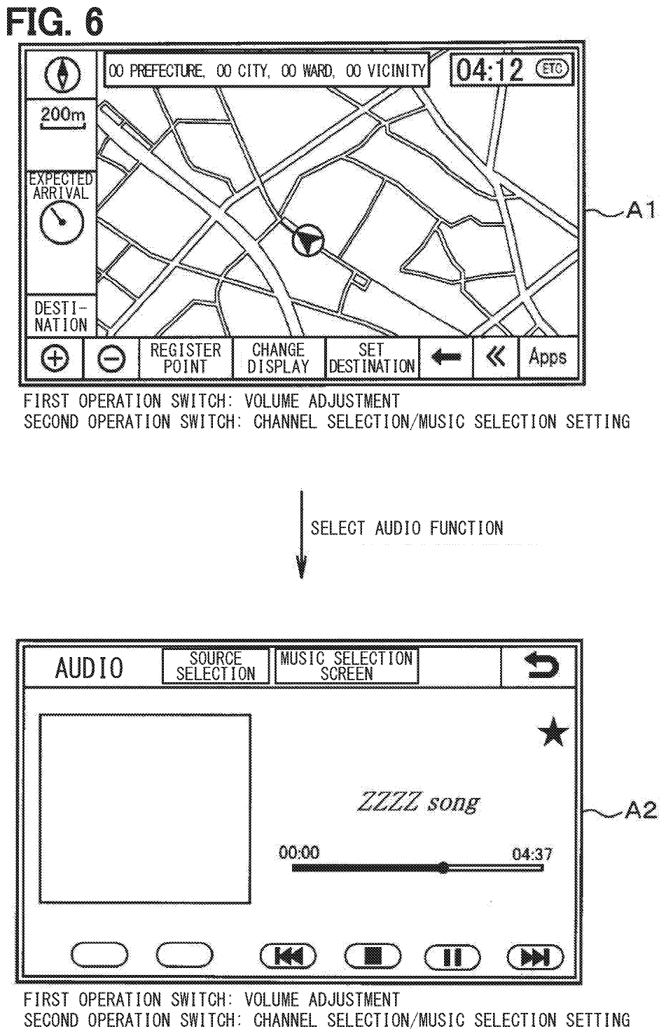

In other words, when the main control unit 12 sets the default display image as the navigation display image, sets the functions of the default operation switches 14 and 15 as the audio functions as shown in FIG. 4, and displays the various display images on the center display 3, the main control unit 12 displays a navigation display image A1 on the center display 3, assigns the volume adjustment to the first operation switch 14, and assigns the channel selection/music selection setting to the second operation switch 15, as shown in FIG. 6, immediately after the vehicle steering switch system 1 is activated. At that time, the user can perform the volume adjustment by operating the first operation switch 14, can adjust the volume to a large value by pressing an upper side of the first operation switch 14, and can adjust the volume to a small value by pressing a lower side of the first operation switch 14. Further, the user can perform channel selection/music selection setting by operating the second operation switch 15, can set channel selection/music selection in ascending order by pressing the upper side of the second operation switch 15, and can set channel selection/music selection in descending order by pressing the lower side.

When the user selects the audio function by operating, for example, the switch of the audio function around the center display 3 from the above state, the main control unit 12 causes the center display 3 to display an audio display image A2, continues the assignment of the volume adjustment to the first operation switch 14, and continues the assignment of the channel selection/music selection setting to the second operation switch 15. In other words, the main control unit 12 switches the display image from the navigation display image A1 to the audio display image A2, and, however, does not switch the functions assigned to the operation switches 14 and 15. In the audio display image A2 shown in FIG. 6 or the like, while a music selection menu such as fast forward or rewind is displayed, a numerical value or an icon bar indicating volume adjustment is not displayed. However, a numerical value or an icon bar indicating the volume adjustment may be displayed.

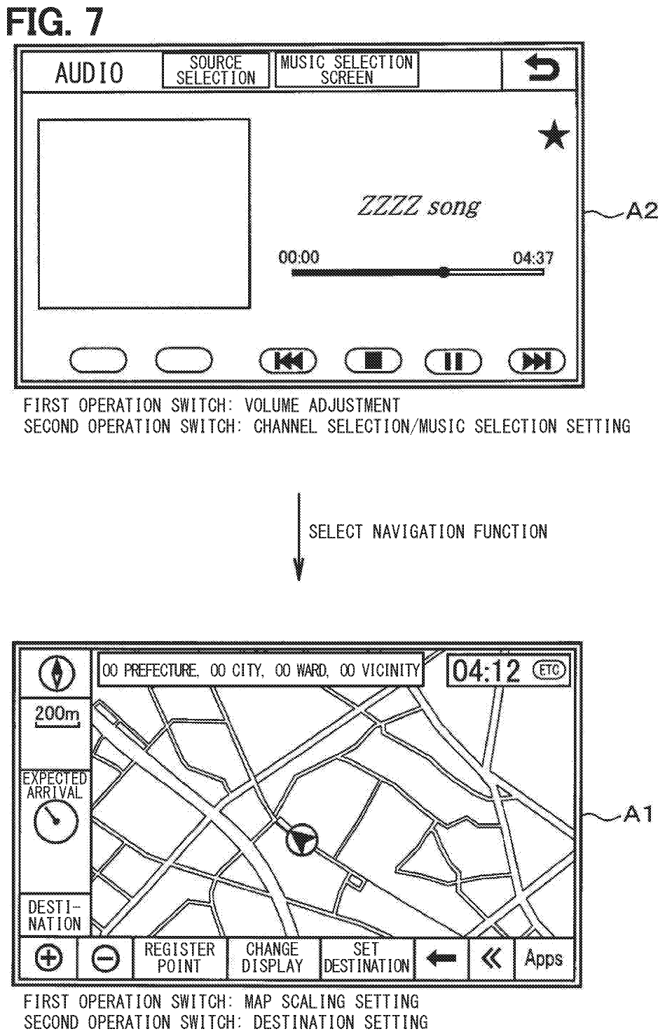

When the user selects the navigation function by operating, for example, the switch of the navigation function around the center display 3 or the second function selection switch 17 from the above state, the main control unit 12 causes the center display 3 to display the navigation display image A1 again, assigns the map scaling setting to the first operation switch 14, and assigns the destination setting to the second operation switch 15, as shown in FIG. 7. In other words, the main control unit 12 switches the display image from the audio display image A2 to the navigation display image A1, and also switches the function assigned to the operation switches 14 and 15 from the audio function to the navigation function. At this time, the user can perform map scaling setting by operating the first operation switch 14, and can enlarge the map by pressing the upper side of the first operation switch 14, and can reduce the map by pressing the lower side. Further, the user can set the destination by operating the second operation switch 15, and can set a home as the destination by pressing the upper side of the second operation switch 15, and can set a registration point as the destination by pressing the lower side. In that case, the main control unit 12 may cause the in-vehicle display 9 to display a mode in which the map scaling setting and the destination setting are changed in conjunction with the user's operation, or may change the display of a length of an icon bar or transition to another display image.

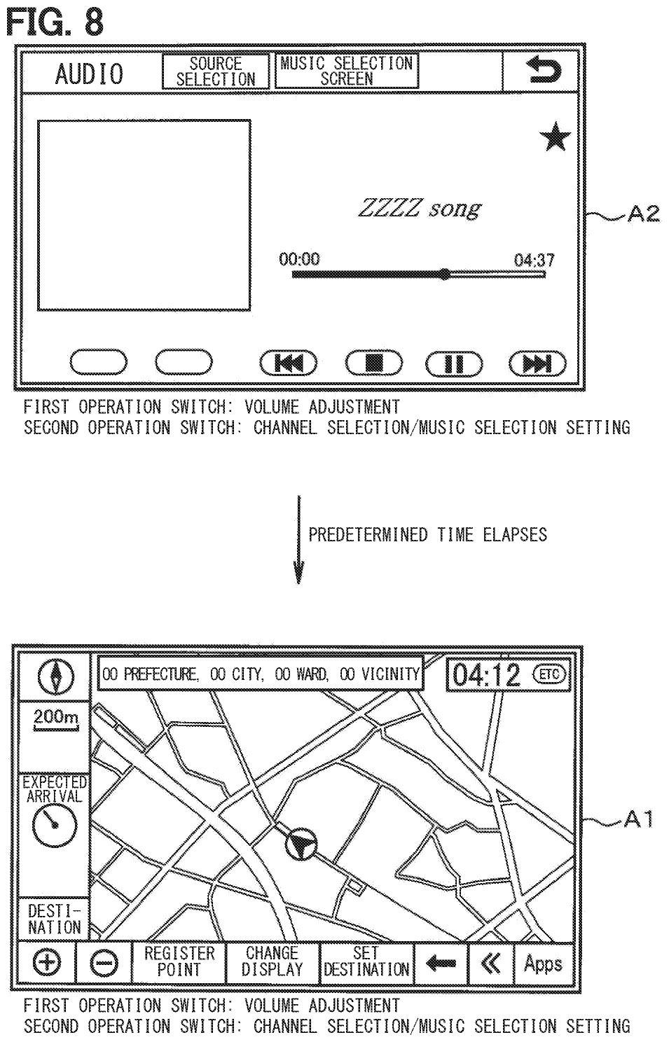

Further, even in a case where the user does not select the navigation function, when a predetermined time period (e.g., 10 seconds) has elapsed from a time, as a starting point, at which the user selects the audio function without operating the operation switches 14 and 15, the main control unit 12 causes the center display 3 to display the navigation display image A1 again, as shown in FIG. 8. However, the main control unit 12 continues the assignment of the volume adjustment to the first operation switch 14 and continues the assignment of the channel selection/music selection setting to the second operation switch 15. In addition, even in a case where the user does not select the navigation function, when a predetermined time period (for example, 10 seconds) has elapsed from a time, as a starting point, at which the user operates the operation switches 14 and 15 without operating the next operation switches 14 and 15, similarly, the main control unit 12 causes the center display 3 to display the navigation display image A1 again. However, the main control unit 12 continues the assignment of the volume adjustment to the first operation switch 14 and continues the assignment of the channel selection/music selection setting to the second operation switch 15. In other words, although the main control unit 12 switches the display image from the audio display image A2 to the navigation display image A1, the main control unit 12 does not switch the function assigned to the operation switches 14 and 15.

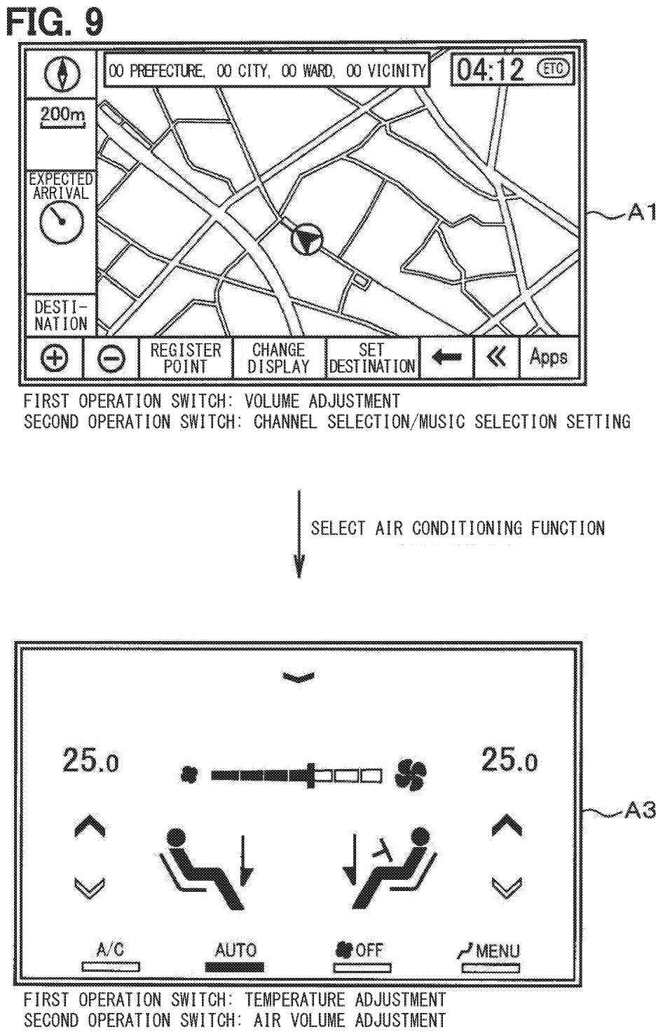

Further, when the user operates, for example, the switch of the air conditioning function or the first function selection switch 16 around the center display 3 to select the air conditioning function from a state where the main control unit 12 causes the navigation display image A1 to be displayed on the center display 3, assigns the volume adjustment to the first operation switch 14, and assigns the channel selection/music selection setting to the second operation switch 15, as shown in FIG. 9, the main control unit 12 causes the air conditioner display image A3 to be displayed on the center display 3, assigns the temperature adjustment to the first operation switch 14, and assigns the air volume adjustment to the second operation switch 15. At that time, the user can perform temperature adjustment by operating the first operation switch 14, and can adjust the temperature to be high by pressing the upper side of the first operation switch 14, and can adjust the temperature to be low by pressing the lower side of the first operation switch 14. In addition, the user can adjust the air volume by operating the second operation switch 15, can strongly adjust the air volume by pressing the upper side of the second operation switch 15, and can weakly adjust the air volume by pressing the lower side of the second operation switch 15. In the air conditioner display image A3 shown in FIG. 9, numerical values and an icon bar indicating the temperature adjustment and the air volume adjustment are displayed. However, the numerical values and the icon bar indicating the temperature adjustment and the air volume adjustment may not be displayed.

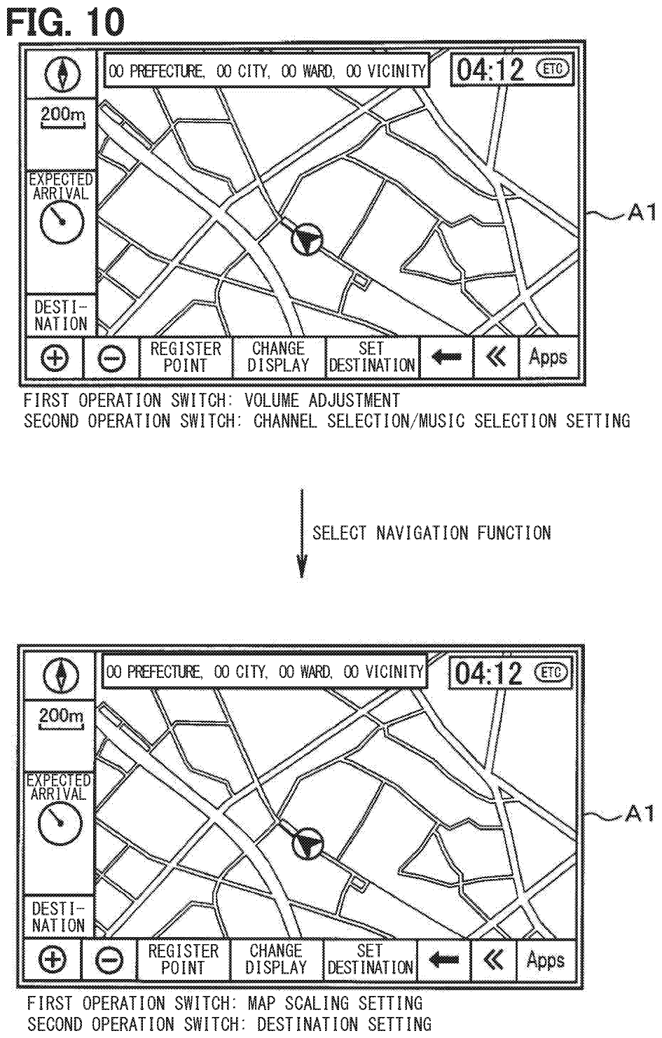

Further, when the user operates, for example, the switch of the navigation function around the center display 3 and the second function selection switch 16 to select the navigation function from the state where the main control unit 12 causes the navigation display image A1 to be displayed on the center display 3, assigns the volume adjustment to the first operation switch 14, and assigns the channel selection/music selection setting to the second operation switch 15, as shown in FIG. 10, the main control unit 12 continues the display of the navigation display image A1, assigns the map scaling setting to the first operation switch 14, and assigns the destination setting to the second operation switch 15.

Although the case where the default display image is set as the navigation display image and the functions of the default operation switches 14 and 15 are set as the audio functions has been described above, the default display image and the functions of the operation switches 14 and 15 may be customizable. In other words, any combination of the default display image and the functions of the operation switches 14 and 15 may be used.

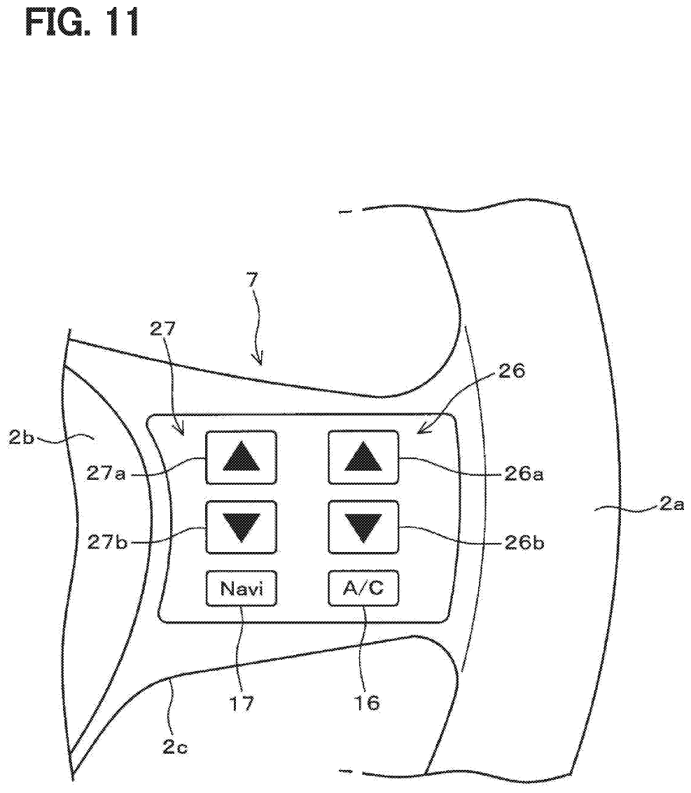

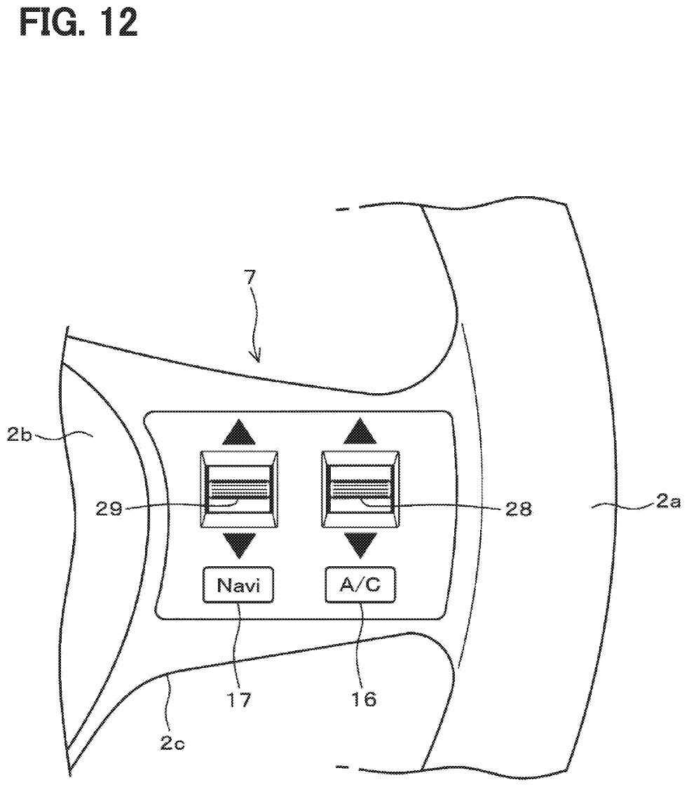

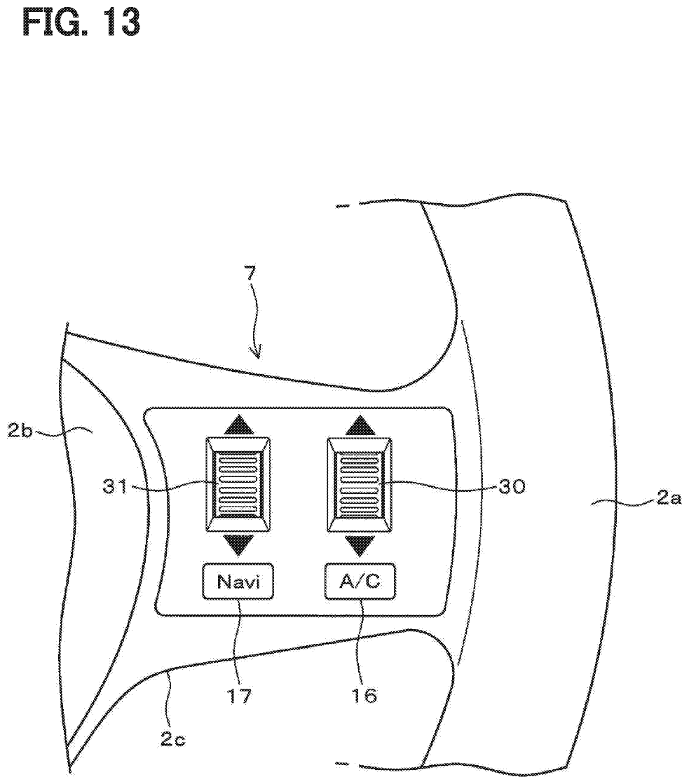

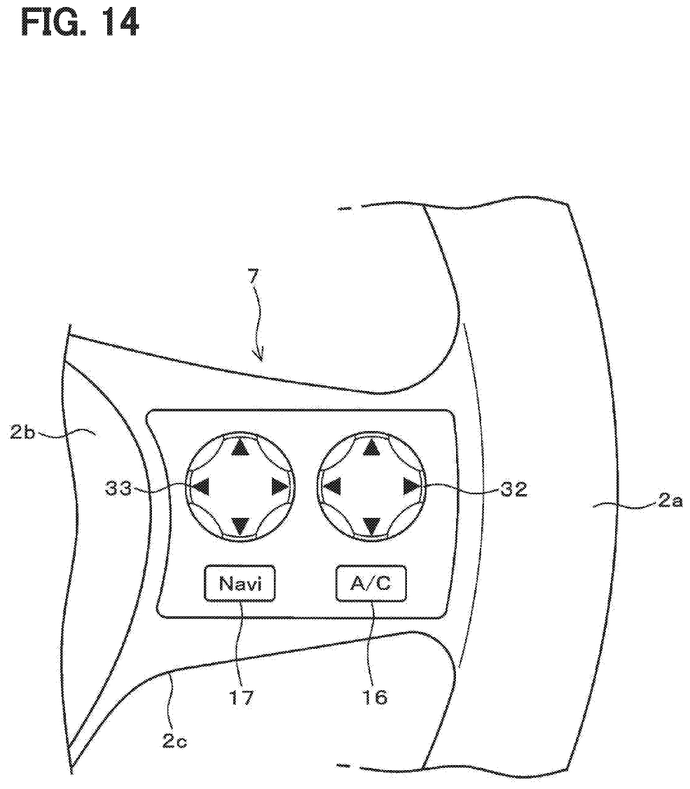

Further, although the operation switches 14 and 15 of the seesaw type have been exemplified above, other types may be adopted. In other words, as shown in FIG. 11, a first operation switch 26 including independent push-type switches 26a and 26b and a second operation switch 27 including switches 27a and 27b may be employed. As shown in FIG. 12, a first operation switch 28 and a second operation switch 29 of a toggle type for raising and lowering a knob may be employed. As shown in FIG. 13, a first operation switch 30 and a second operation switch 31 of a wheel type for rotating a knob may be employed. As shown in FIG. 14, a first operation switch 32 and a second operation switch 33 of a cross key type may be employed. The cross key type may have a determination button at the center.

As described above, according to the first embodiment, the following effects can be obtained.

In the vehicle steering switch system 1, a display image displayed on the in-vehicle display 9 is associated with functions assigned to the operation switches 14 and 15. Even when the user does not gaze on the display image, the user can recognize the function assigned to the operation switches 14 and 15 at that point in time only by observing the display image for a moment. As a result, the user can appropriately adjust and set multiple functions without increasing the number of the operation switches 14 and 15 and without confusing the user.

In addition, the user performs the function selection operation to switch the display image displayed on the in-vehicle display 9 and switch the functions assigned to the operation switches 14 and 15. The user performs a desired function selection operation, thereby being capable of appropriately adjusting or setting a desired function.

Further, when the elapsed time period has reached a predetermined time period, the elapsed time period starting from a time at which the user performs the function selection operation and, the user's operation on the operation switches 14 and 15 being not detected during the elapsed time period, the display image is switched to the display image of the default function, and the function assigned to the operation switches 14 and 15 is switched to the default function. Even when the user does not perform the operation of returning to the default function, the function assigned to the display image and the operation switches 14 and 15 can be automatically returned to the default function.

Also, when the elapsed time period exceeds a predetermined time period, the elapsed time period starting from a time at which the user performs the operation of the operation switches 14 and 15 and, the next operation of the operation switches 14 and 15 by the user being not detected during the elapsed time period, the display image is also switched to the display image of the default function, and the function assigned to the operation switches 14 and 15 is switched to the default function. Even when the user does not perform the operation of returning to the default function, the function assigned to the display image and the operation switches 14 and 15 can be automatically returned to the default function.

### Second Embodiment

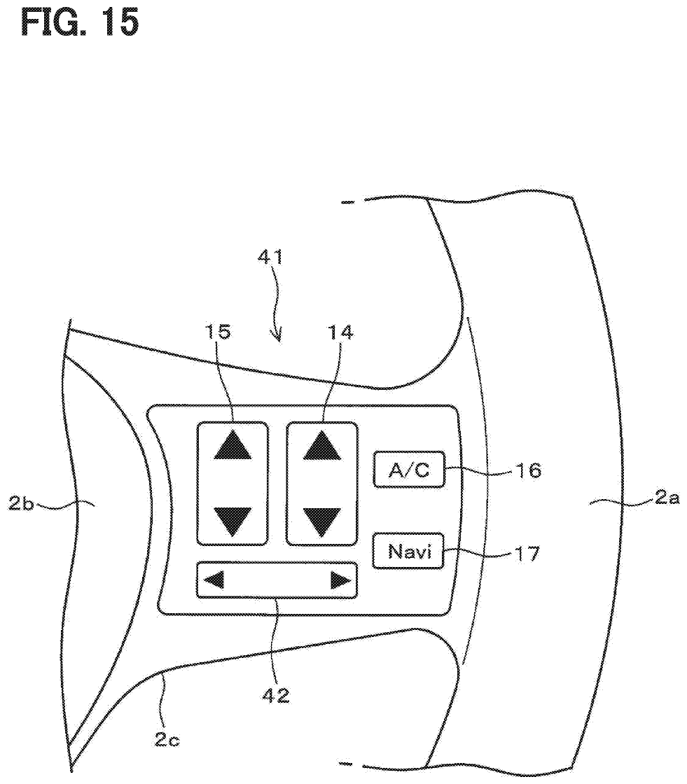

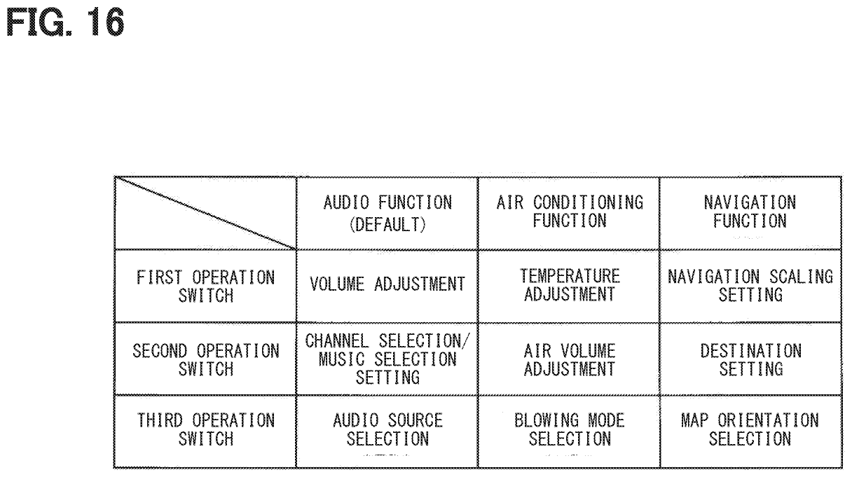

Next, a second embodiment will be described with reference to FIGS. 15 and 16. A description of the same parts as those of the first embodiment will be omitted, and different parts will be described. The first embodiment has a configuration in which two operation switches 14 and 15 are disposed as operation switches, while the second embodiment has a configuration in which three operation switches are disposed as operation switches.

As shown in FIG. 15, a right switch group 41 disposed on a right spoke portion 2c of a steering wheel 2 has a third operation switch 42 in addition to the operation switches 14 and 15 and the function selection switches 16 and 17 described in the first embodiment. The third operation switch 42 is a seesaw-type switch that is disposed below the operation switches 14 and 15, and can be tilted in a lateral direction. The function selection switches 16 and 17 are aligned side by side in a vertical direction on a right side of the first operation switch 14 when viewed from the user. In that case, association between the operation switches 14, 15, and 42 and the various functions of an audio function, an air conditioning function, and a navigation function is set as shown in FIG. 16.

When the audio function is assigned to the operation switches 14, 15, and 42, the user can select an audio source by operating the third operation switch 42, select an audio source in ascending order by pressing a right side of the third operation switch 42, and select an audio source in descending order by pressing a left side. When the air conditioning function is assigned to the operation switches 14, 15, and 42, the user can select a blowing mode by operating the third operation switch 42, select the blowing mode in ascending order by pressing the right side of the third operation switch 42, and select the blowing mode in descending order by pressing the left side. When the navigation function is assigned to the operation switches 14, 15, and 42, the user can select a map direction by operating the third operation switch 42, select a traveling direction upward by pressing the right side of the third operation switch 42, and select a north direction upward by pressing the left side of the third operation switch 42.

As described above, according to the second embodiment, the same operation and effects as those of the first embodiment can be obtained. According to the second embodiment, the degree of freedom of combination can be increased by increasing the number of operation switches. The number of operation switches may be four or more.

### Third Embodiment

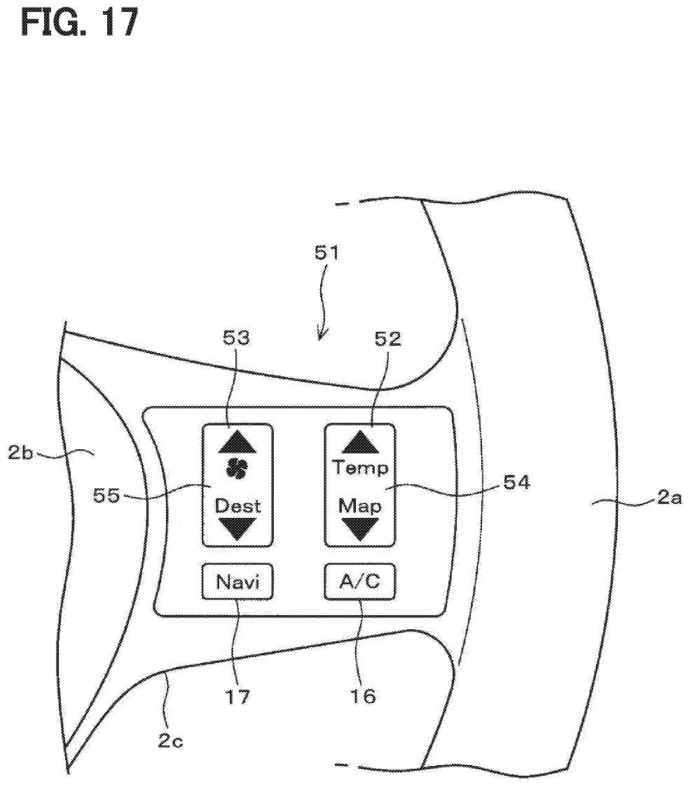

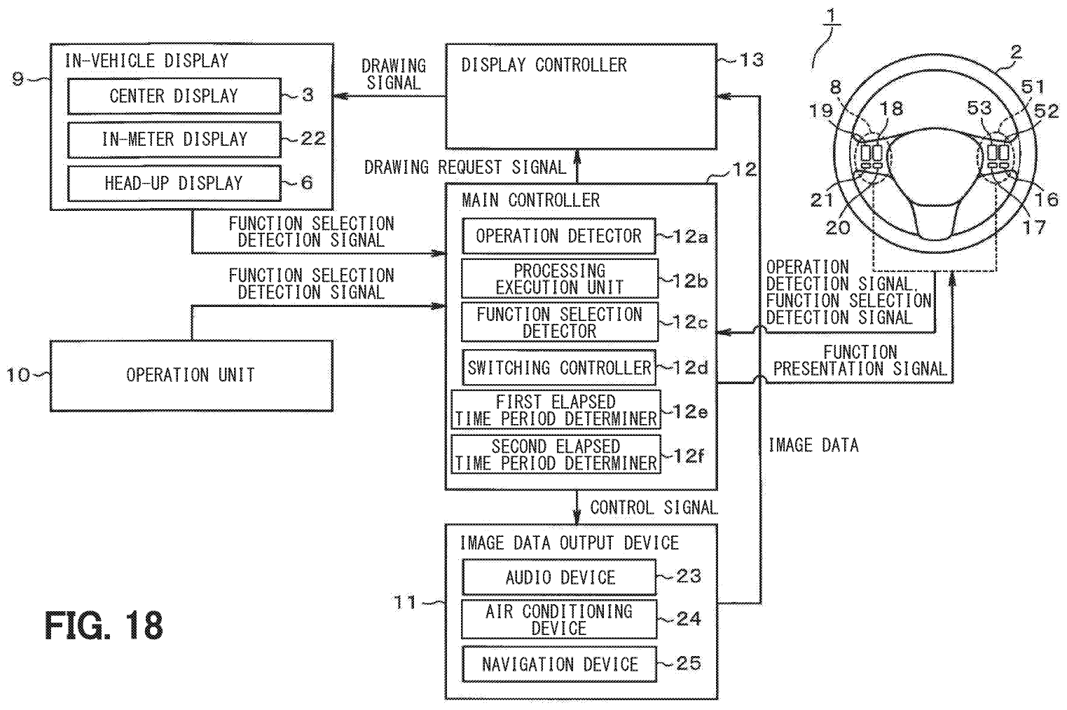

Next, a third embodiment will be described with reference to FIGS. 17 to 21. A description of the same parts as those of the first embodiment will be omitted, and different parts will be described. In the third embodiment, operation switches 14 and 15 are provided with a function presentation unit for presenting assigned functions.

As shown in FIG. 17, a right switch group 51 disposed on a right spoke portion 2c of a steering wheel 2 has operation switches 52 and 53 and function selection switches 16 and 17. The first operation switch 52 has a function presentation unit 54 in the vicinity of the central portion of the first operation switch 52, and when receiving a function presentation signal from a main control unit 12, the first operation switch 52 alternatively displays a mark (letter “Temp”) indicating a temperature adjustment of an air conditioning function and a mark (letter “Map”) indicating a map scaling setting of a navigational function in the function presenting unit 54 according to the received function presentation signal. The second operation switch 52 has a function presentation unit 55 in the vicinity of a central portion of the second operation switch 52, and when receiving a function presentation signal from the control unit 12, the second operation switch 52 alternatively displays a mark indicating an air volume adjustment of an air conditioning function (figure of windmill”) and a mark “Dest” indicating a destination setting of the navigation function in the function presentation unit 55.

The switching controller 12d switches a display image displayed on an in-vehicle display 9, functions assigned to the operation switches 14 and 15, and the presentation of the function presentation units 54 and 55 in association with each other. When the function selected by the user is identified by a function selection detector 12c as described above, the switching controller 12d outputs a drawing request signal corresponding to the identified function to a display control unit 13, processes signals input from the operation switches 14 and 15 thereafter in accordance with the identified function, and outputs the function presentation signal to the function presentation units 54 and 55.

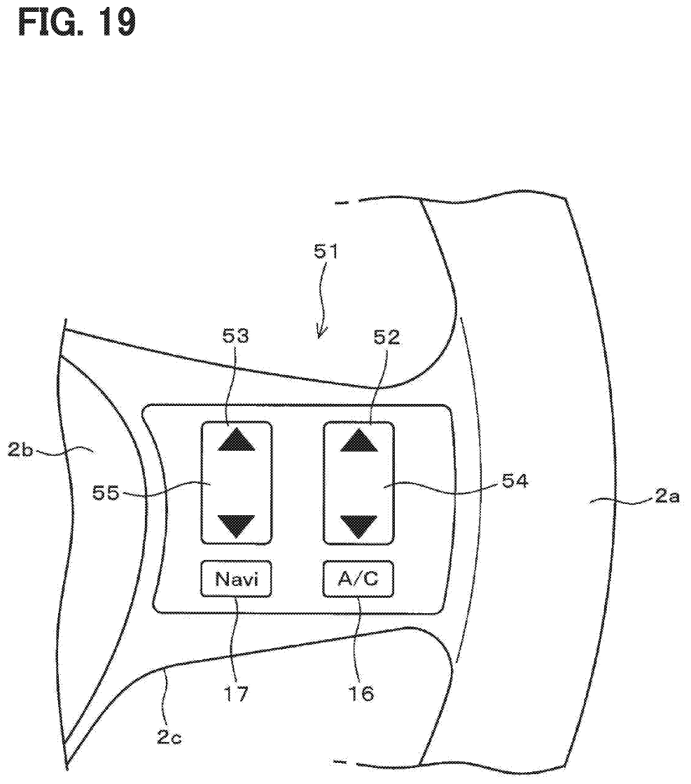

In that case, when the audio function is allocated to the operation switches 14 and 15, the main control unit 12 allocates a volume adjustment to the first operation switch 14, allocates a channel selection/music selection setting to the second operation switch 15, and does not display any marks on the function presentation units 54 and 55, as shown in FIG. 19. In other words, the user can recognize that the audio function is assigned to the operation switches 14 and 15 by not displaying any marks on the function presentation units 54 and 55.

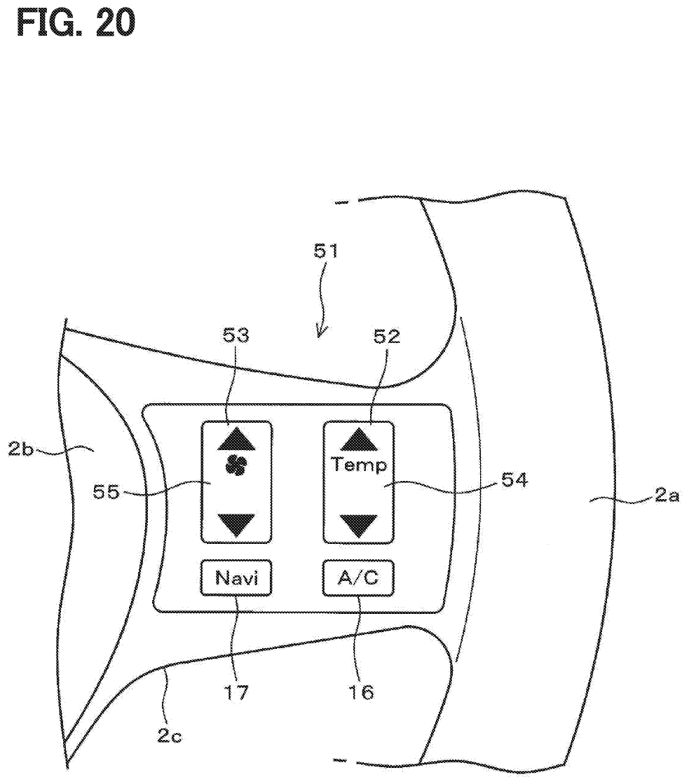

When the air conditioning function is assigned to the operation switches 14 and 15, the main control unit 12 assigns the temperature adjustment to the first operation switch 14, assigns the air volume adjustment to the second operation switch 15, causes a mark indicating the temperature adjustment to be displayed on the function presentation unit 54, and causes a mark indicating the air volume adjustment to be displayed on the function presentation unit 55, as shown in FIG. 20. In other words, the user can recognize that the air conditioning function is assigned to the operation switches 14 and 15 by displaying the marks of the air conditioning function on the function presentation units 54 and 55.

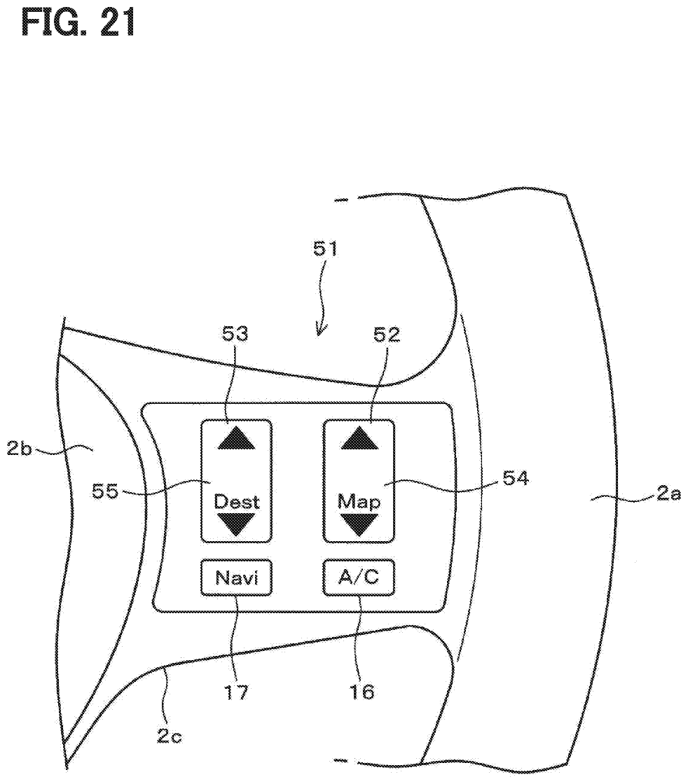

When the navigation function is assigned to the operation switches 14 and 15, the main control unit 12 assigns the map scaling setting to the first operation switch 14, assigns the destination setting to the second operation switch 15, causes a mark indicating the map scaling setting to be displayed on the function presentation unit 54, and causes a mark indicating the destination setting to be displayed on the function presentation unit 55, as shown in FIG. 21. In other words, the user can recognize that the navigation function is assigned to the operation switches 14 and 15 by displaying the navigation function marks on the function presentation units 54 and 55.

As described above, according to the third embodiment, the same operation and effects as those of the first embodiment can be obtained. According to the third embodiment, the function assigned to the operation switches 14 and 15 can be reliably grasped by the user by displaying the marks on the function presentation units 54 and 55.

### Other Embodiments

Although the present disclosure has been described in accordance with the examples, it is understood that the present disclosure is not limited to such examples or structures. The present disclosure encompasses various modifications and variations within the scope of equivalents. In addition, various combinations and configurations, as well as other combinations and configurations that include only one element, more, or less, fall within the scope and spirit of the present disclosure.

The functions of the multimedia system may be functions other than the audio function, the air conditioning function, and the navigation function.

Although the case where various display images are displayed on the center display 3 has been exemplified, various display images may be displayed on the in-meter display 22 or the head-up display 6.

Although the right switch group 7 is exemplified, the left switch group 8 may also be applied.

The controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

1. A vehicle steering switch system comprising:
an operation switch that is disposed in a vehicle steering wheel;
a display configured to display a display image;
an operation detector configured to detect operation of a user on the operation switch;
a processing execution unit configured to execute, when the operation detector detects the operation by the user on the operation switch, a process corresponding to a function assigned to the operation switch at a detected time; and
a switching controller configured to
associate the display image displayed on the display to the function assigned to the operation switch
perform switching of the display or the function.

2. The vehicle steering switch system according to claim 1, wherein:
the switching controller switches the function assigned to the operation switch from a first function to a second function at a timing of switching the display image from the display image of the first function to the display image of the second function.

3. The vehicle steering switch system according to claim 2, wherein:
the switching controller switches the function assigned to the switch from the second function to the first function at a timing of switching the display image from the display image of the second function to the display image of the first function after switching the function assigned to the switch from the first function to the second function.

4. The vehicle steering switch system according to claim 2, further comprising:
a function selection detector configured to detect function selection operation by the user,
wherein:
the switching controller is configured to switch the display image from the display image of the first function to the display image of the second function when the function selection operation by the user from the first function to the second function is detected in a state where the display image of the first function is displayed.

5. The vehicle steering switch system according to claim 4, wherein:
the switching controller is configured to switch the display image from the display image of the second function to the display image of the first function when the function selection operation by the user from the second function to the first function is detected after switching the display image from the display image of the first function to the display image of the second function.

6. The vehicle steering switch system according to claim 4, further comprising:
a first elapsed time period determiner configured to determine whether a first elapsed time period exceeds a first predetermined time period, the first elapsed time period starting from a time at which the function selection operation by the user is detected, and the operation by the user on the operation switch being not detected during the first elapsed time period,
wherein:
the switching controller switches the display image from the display image of the second function to the display image of the first function when the first elapsed time period determiner determines that the first elapsed time period exceeds the first predetermined time period after the display image is switched from the display image of the first function to the display image of the second function.

7. The vehicle steering switch system according to claim 4, further comprising:
a second elapsed time period determiner configured to determine whether a second elapsed time period exceeds a second predetermined time period, the second elapsed time period starting from a time at which the operation by the user on the operation switch is detected, and a next operation by the user on the operation switch being not detected during the second elapsed time period,
wherein:
the switching controller switches the display image from the display image of the second function to the display image of the first function when the second elapsed time period determiner determines that the second elapsed time period exceeds the second predetermined time period after the display image is switched from the display image of the first function to the display image of the second function.

8. The vehicle steering switch system according to claim 1, wherein:
the operation switch has a function presentation unit configured to present an assigned function, and
the switching controller is configured to
associate the display image displayed on the display, the function assigned to the switch, and the presentation of the function by the function presentation unit and
perform the switching.

9. A computer readable non-transitory storage medium storing a switch function switching program configured to cause a vehicle steering switch system including an operation switch disposed in a vehicle steering wheel and a display that displays a display image to execute:
a condition fulfillment determination procedure that determines whether a condition for switching a function assigned to the operation switch is fulfilled; and
a switching control procedure that associates the display image displayed on the display and a function assigned to the operation switch and performs switching of the display image or the function when the condition fulfillment determination procedure determines that the condition for switching the function assigned to the operation switch is fulfilled.
